(19) United States
(12) Patent Application Publication
(10) Pub. No.: US 2007/0060155 A1
(43) Pub. Date: Mar. 15, 2007

(54) System and method to dynamically adapt a CCA threshold

(76) Inventors: Emanuel Kahana, Chicago, IL (US); Robert J. Corke, Glen Ellyn, IL (US); Daniel G. Prysby, Elk Grove Village, IL (US); Ron Rotstein, Austin, TX (US)

Correspondence Address: MOTOROLA, INC., 1303 EAST ALGONQUIN ROAD, IL01/3RD, SCHAUMBURG, IL, 60196, US

(21) Appl. No.: 11/216,625

(22) Filed: Aug. 31, 2005

(51) Int. Cl. H04Q 7/20

(52) U.S. Cl. 455/450

(57) ABSTRACT

The present invention relates to a method, device and system for dynamically adapting a clear channel assessment threshold of a wireless communications channel by determining the status of a busy channel indicator for at least a first parameter (105) and dynamically changing the clear channel assessment threshold based on the status of the busy channel indicator (110).

### FIELD OF THE INVENTION

The present invention relates generally to clear channel assessment in a wireless communication network and more specifically to controlling the clear channel assessment threshold in a wireless local area network.

### BACKGROUND OF THE INVENTION

A communication channel, e.g., a radio frequency (RF) channel, comprises a receiver and a transmitter. The transmitter sends a communication signal in the form of a data packet (also known as a datagram in the art) to the receiver across the channel. A preamble, used for receiver packet detection, synchronization, channel estimation, etc., typically heads the data packet. The signal, which may be impaired by a channel response, additive noise and possibly interference, arrives at the receiver. In a multi-user communications system using a shared random access channel topology, a carrier sense multiple access/collision avoidance (CSMA/CA) methodology or protocol may be employed in order to avoid collisions on the channel. The receiver, which is monitoring the channel for the presence of energy, may indicate the status of the RF channel by setting the state of an indicator according to the presence of energy in the channel. There are several ways to indicate whether the channel is busy (unavailable) or clear (available) to permit transmission of data. A clear channel assessment CCA mechanism (also referred to herein simply as a CCA) provides one such indication.

For example, the Institute of Electrical and Electronics Engineering (IEEE) 802.11 standards for a wireless local area network (WLAN) implements a CSMA/CA access methodology, which is a contention-based protocol. In the receiver, a signal or indicator known as clear channel assessment (CCA) is used to indicate the status of the channel. A received signal strength (RSS) is further used to indicate whether the channel is occupied, and is also referred to as CCA sensitivity. According to the 802.11 standards, the CCA sensitivity depends on the detection of a start of a valid Orthogonal Frequency Division Multiplexing (OFDM) transmission, e.g., a preamble. When a valid preamble is detected with an RSS at or above a CCA threshold that is a minimum RSS value (e.g., 6 Mbps, −82 dBm), the CCA indicates a channel busy status. In the absence of a detected preamble, the CCA threshold for indicating a busy channel is 20 dB above the 6 Mbps sensitivity or −62 dBm. In the case of preamble detection, the CCA will indicate a clear channel when either the RSS falls below −82 dBm, or the preamble is rejected. In the case of no preamble detection with an RSS above −62 dBm, the CCA indicates a busy channel even if a valid OFDM signal is not identified or in the presence of noise, until the energy falls below −62 dBm. The specified thresholds for CCA, thus, assume that signals with energy above −62 dBm are valid OFDM signals, which may enable a malicious intruder to cause a serious disruption of service. For example, an intruder can repeatedly transmit a preamble at just above −82 dBm, causing the CCA to indicate busy until the preamble is rejected. The intruder may also transmit a simple jamming signal with received energy just above −62 dBm, causing the CCA to indicate busy continuously. This may reduce the quality of service (QoS) to an unacceptable level.

Thus, there is a need for a method to dynamically adapt or adjust the CCA threshold in response to external conditions.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a flow diagram illustrating a method to dynamically adapt a clear channel assessment threshold in a communication channel in accordance with one embodiment of the present invention.

FIG. 2 is a flow diagram illustrating a method to dynamically adapt a clear channel assessment threshold in a communication channel using a time interval as a parameter in accordance with one embodiment of the present invention.

FIG. 3 is a state diagram illustrating a method to dynamically adapt a clear channel assessment threshold in a communication channel using a time interval as a parameter in accordance with one embodiment of the present invention.

FIG. 4 is a signal diagram depicting a method to adapt a clear channel assessment threshold in a communication channel using a time interval as a parameter in accordance with one embodiment of the present invention.

FIG. 5 is a flow diagram illustrating a method to adapt a clear channel assessment threshold in a communication channel using received signal strength as a parameter in accordance with one embodiment of the present invention.

FIG. 6 is a circuit diagram of apparatus used to adapt a clear channel assessment threshold in a communication channel using received signal strength as a parameter in accordance with one embodiment of the present invention.

FIG. 7 is a signal diagram depicting a method to adapt a clear channel assessment threshold in a communication channel using received signal strength as a parameter in accordance with one embodiment of the present invention.

FIG. 8 illustrates a block diagram of a communication system that may implement various embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus to dynamically adapt a CCA threshold Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus to dynamically adapt the CCA threshold described herein. The non-processor circuits may include, but are not limited to, a radio receiver, a radio transmitter, signal drivers, clock circuits, power source circuits, and user input devices. As such, these functions may be interpreted as steps of a method to perform the function of dynamically adapting the CCA threshold described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments of making a clear channel assessment (CCA) threshold adaptable in response to external conditions in a wireless network, for example in a wireless network based on the 802.11 standards, are described. However, skilled artisans will realize and appreciate that the embodiments described herein are not limited to 802.11 implementations but may be applied within various other types of communication networks. The CCA threshold can be varied based on one or more parameters. For example, a time interval or a received signal strength can serve as such parameters upon which the adjustment of the CCA threshold can be based. The methods disclosed herein for adapting the CCA threshold are complimentary, can be used to address different types of jamming, and can be implemented on a single communication system. The communication system may comprise one or more access points and/or one or more stations. The embodiments disclosed are generally implemented at a Physical Layer level, for instance of the well known Open System Interconnection (OSI) networking model. However, those skilled in the art will appreciate that varied implementations of the methods disclosed are possible and all such methods are within the scope of the present invention.

One embodiment of the present invention adjusts a CCA threshold based on a busy channel indicator of a CCA. A communication channel is said to be busy when the busy channel indicator indicates a busy status, for instance when a RSS is greater than the CCA threshold. Similarly, the communication channel is said to be clear when the busy channel indicator indicates a clear status, for instance when the RSS is less than the CCA threshold. The clear status indication permits a user to use the communication channel to transmit data. However, a user is not permitted to use the channel for transmitting data when the communication channel is in use, e.g., when the busy channel indicator indicates a busy status.

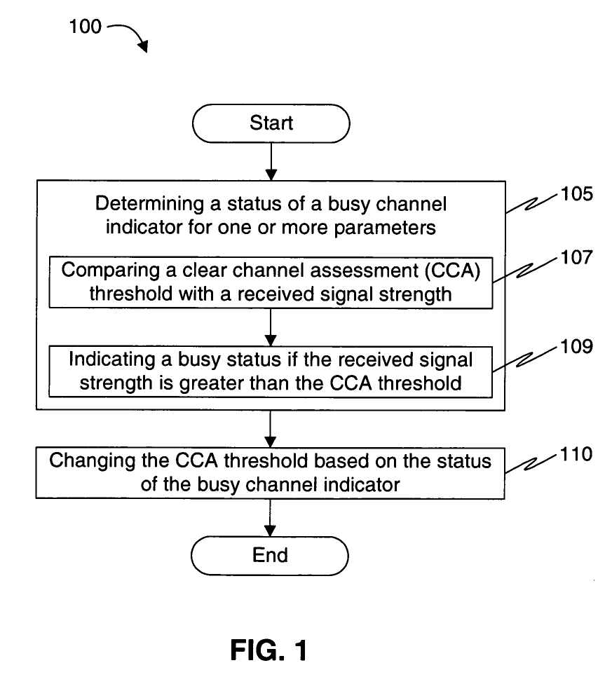

Turning now to FIG. 1, a flow diagram of a method for adapting a clear channel assessment (CCA) threshold of or associated with a communication channel in accordance with one embodiment of the present invention is shown and indicated generally at 100. The CCA threshold is made adaptable in response to external conditions. An indicator referred to as a busy channel indicator of the communication channel may switch from indicating a busy status to a clear status (or vice versa) based on the received signal strength (RSS) that may be, for instance, based on data being transmitted from various devices over the communication channel.

There are several ways to determine whether the channel is busy or clear to permit transmission of data. A clear channel assessment (CCA) represents one such mechanism. To avoid having a status of a busy channel indicator remaining busy for long periods of time, a CCA threshold can be made adaptable and varied based on the status of the busy channel indicator. In general, one embodiment of the present invention comprises determining a status of a busy channel indicator for one or more parameters, step 105, and changing the CCA threshold based on the status of the busy channel indicator, step 110. The CCA threshold can be decreased or increased based on the status of the busy channel indicator. In the embodiment illustrated by reference to FIG. 1, the one or more parameters may include received signal strength (RSS). Accordingly, the RSS can be monitored for a predetermined time interval and compared with a current CCA threshold, step 107. The busy channel indicator, thereby, switches to a busy status when the RSS is greater than the CCA threshold, step 109.

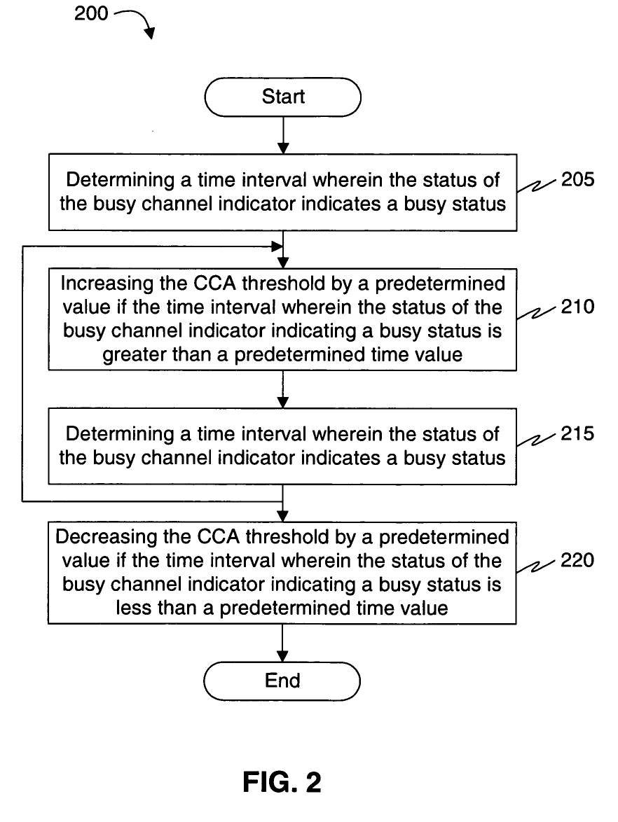

Turning now to FIG. 2, a flow diagram illustrating a method for adapting a clear channel assessment threshold in a wireless communication channel pursuant to one embodiment of the present invention is shown and indicated generally at 200. In accordance with this embodiment, the one or more parameters upon which the adjustment of the CCA threshold may be based includes a time interval. Accordingly, a time interval wherein the status of the busy channel indicator indicates a busy status may be determined, step 205. If the time interval exceeds a first predetermined time value, the CCA threshold can be increased by a predetermined value, step 210. Correspondingly, once the CCA threshold has been increased, the CCA threshold can be decreased by a predetermined value if the time interval in which the busy channel indicator indicates the busy status is less than a second predetermined time value, step 220. Those skilled in the art may appreciate, that the predetermined value by which the CCA threshold is increased can be different from the predetermined value by which the CCA threshold is decreased, or these values can be the same depending on the particular implementation. Moreover, the first and second predetermined time values can be the same or different depending on the particular implementation. However, the first predetermined time value is generally higher than the second predetermined time value to avoid hysteresis and prevent oscillations. Those skilled in the art will appreciate that the first predetermined time value, second predetermined time value and the predetermined value by which the CCA threshold can be varied may further be, for instance, preset values that are configurable based on system requirements, as is generally known in the art.

In one illustrative embodiment, a time period Y can be measured. Further, a time period Z can be measured, wherein Z represents a time during which the busy channel indicator indicates a busy status within time period Y. A ratio Y/Z, e.g., a first time interval, may then be calculated and compared with a first predetermined time value. If the ratio Y/Z is greater than the first predetermined time value, the CCA threshold can be increased by a first predetermined value. If after the CCA threshold has been increased, the ratio Y/Z, e.g., a second time interval, is less than a second predetermined time value, the CCA threshold can be reduced by a second predetermined value.

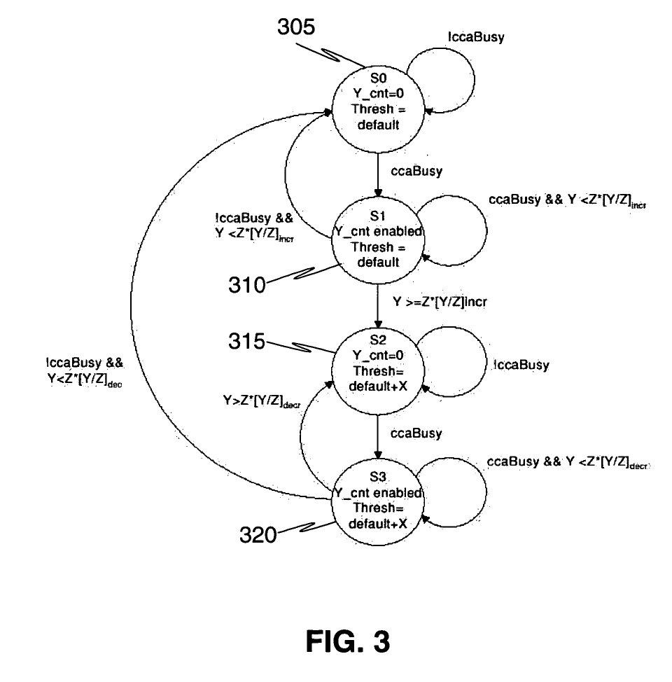

FIG. 3 is a state diagram showing a possible implementation of the above embodiment. A CCA busy signal is derived from a default CCA threshold. The default CCA threshold is a fixed CCA threshold value. The CCA busy signal is independent of the status of the busy channel indicator and is used along with a time counter Y_cnt to determine the status of the busy channel indicator and hence a current CCA threshold used to indicate the CCA status (clear or busy) to a media access control (MAC) entity. The Y_cnt is related to time according to the equation time=Y_cnt/(clock frequency). The first predetermined time value is represented by [Y/Z]_{incr} and the second predetermined time value is represented by [Y/Z]_{decr}. The comparison of the ratio Y/Z to the predetermined values, [Y/Z]_{incr} and [Y/Z]_{decr} may be accomplished without division by comparing Y_cnt to Z[Y/Z]_{incr} and Z[Y/Z]_{decr}.

The CCA threshold is varied based on the timings of the busy channel indicator. To begin with, the Y_cnt is set at zero and the CCA threshold is set at the default CCA threshold (305). The Y_cnt increases as the time interval indicating the busy status of the CCA increases. The Y_cnt is set at zero when the CCA indicates the clear status. It remains in that status as long as the CCA indicates a clear status. Once the busy channel indicator changes its status from the clear status to the busy status Y_cnt is enabled (310). The Y_cnt on being enabled is constantly compared with Z[Y/Z]_{incr}. Y_cnt is set back to zero when the busy channel indicator stops indicating the busy status and if the Y_cnt is less than Z[Y/Z]_{incr}. It remains in this status as long as the busy channel indicator indicates the busy status and Y_cnt is less than Z[Y/Z]_{incr}. Once the Y_cnt crosses the Z[Y/Z]_{incr} value the CCA threshold is incremented by a predetermined value X (315) to an increased threshold value.

The CCA threshold remains at the increased threshold value (with Y_cnt being set at zero) as long as the busy channel indicator indicates a clear status. The Y_cnt is only enabled when the busy channel indicator indicates a busy status. Once the busy channel indicator indicates the busy status the Y_cnt is compared with Z[Y/Z]_{decr}. Checking again for the CCA status leads to four conditions. Where the CCA is not busy, and Y_cnt is greater than Z[Y/Z]_{decr}, the Y_cnt is set at zero and the CCA threshold at an increased threshold value as shown at the third state 315. Next, where the CCA is not busy and Y_cnt is less than Z[Y/Z]_{decr}, the CCA threshold is decremented by a predetermined value X to a decreased threshold value that leaves the CCA threshold back to the default CCA threshold, and Y_cnt set at zero as shown at the first state 305. Further, where the CCA indicates busy, Y_cnt is compared with Z[Y/Z]_{decr} and if the Y_cnt is greater than Z[Y/Z]_{decr}, the Y_cnt is set back to zero as shown at the third state 315. Lastly, where the Y_cnt is less than Z[Y/Z]_{decr} then Y_cnt continues counting with CCA threshold set at default CCA threshold value as shown in the fourth state 320.

For the state diagram shown in FIG. 3, Y_cnt is a time parameter and is compared to a first predetermined time value Z[Y/Z]_{incr}. Accordingly, the busy channel indicator can indicate the busy status continuously for a sufficiently long time interval for the CCA threshold to increase by a predetermined value. Thereafter, if the status of the busy channel indicates a busy status for more than the first predetermined time value, the CCA threshold may again be increased by the predetermined value. The higher the CCA threshold, the more difficult it is for the busy channel indicator to indicate the busy status.

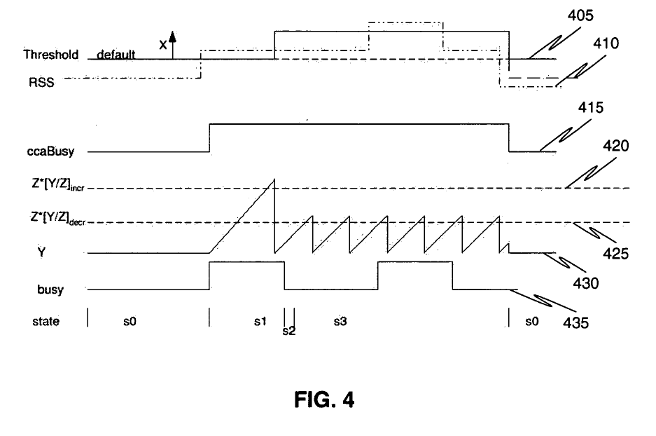

Turning now to FIG. 4, a signal diagram corresponding to the state diagram illustrated in FIG. 3 is shown and indicated generally. Signal 405 represents the CCA threshold that is illustrated as starting at a default value at a state s0. Signal 410 represents the received signal strength (RSS), and signal 415 a CCA busy signal. The CCA busy signal is derived from the default CCA value and the RSS 410. The first predetermined time value Z[Y/Z]_{incr} is represented as signal 420, the second predetermined time value Z[Y/Z]_{decr} is illustrated using signal 425. The first predetermined time value may be the same as the second predetermined time value. The Z[Y/Z]_{incr} and Z[Y/Z]_{decr} values can also be different, but generally the Z[Y/Z]_{incr} value is kept at a marginally higher value than the Z[Y/Z]_{decr} value to avoid hysteresis and avoid oscillations. The parameter Y_cnt, a time counter, is represented using signal 430. Signal 435 represents an output of the busy channel indicator in a communication system according to an embodiment of the present invention.

Prior art systems maintain a constant CCA threshold. According to one embodiment of the present invention the CCA threshold is varied based on a time interval parameter associated with the busy channel indicator, for example, the amount of time the busy channel indicator maintains a busy status. The status of the busy channel indicator indicates a busy status when the RSS exceeds the CCA threshold. As per the embodiments disclosed, the busy channel indicator would now indicate a busy status for a more limited period of time owing to the adaptive nature of the CCA threshold represented using the signal diagram. As soon as the CCA threshold is increased, the busy channel indicator switches back to a clear status allowing transmission of data. This facilitates the usage of the communication channel by more users by reducing the amount of time the channel is considered to be occupied. This in turn increases the system efficiency and also the quality of service (QoS) offered by the communication channel.

As shown in FIG. 4 beginning at state s1, CCA 435 indicates a busy status on the channel. The CCA 405 threshold may be raised from the default value by X dB, beginning at state s2, when the time Y in which CCA indicates “busy” divided by a period of time Z is greater than [Y/Z]_{incr} 420. Once the CCA 405 threshold has been increased, it does not change until the CCA busy indication time interval is less Z[Y/Z]_{decr} 425 (e.g., at the completion of state s3), at which time the CCA threshold is decreased. The values of X, [Y/Z]_{incr} 420, [Y/Z]_{decr} 425 and Z are programmable, but [Y/Z]decr 425 is less than [Y/Z]_{incr} 420, to create a hysteresis and avoid oscillations. For example, if a counter value, Y, is incremented at the rate of 1 count per 100 usec, and the maximum allowable channel busy time is 2 ms, then Z and [Y/Z]_{incr} would be chosen such that Z[Y/Z]_{incr} is equal to 20. Similarly, if the channel busy time required to go from state 3 to state 0 in FIG. 3 is 1 ms, that Z and [Y/Z]_{dec} are chosen such that Z[Y/Z]_{dec} is equal to 10. The ccaBusy signal 415 is derived from the default CCA threshold value, independent of the current status of the busy channel indicator and is used along with the “Y_cnt” value 430 to determine the current status and hence the current CCA threshold used to indicate the CCA status (clear or busy) to the MAC entity. The Y_cnt 430 is related to time by the equation time=Y_cnt/(clock frequency). The comparison of the ratio [Y/Z] to the thresholds, [Y/Z]_{incr} 420 and [Y/Z]_{decr} 425, is accomplished without division by comparing Y_cnt 330 to Z[Y/Z]_{incr} 420 and [Y/Z]_{decr} 425.

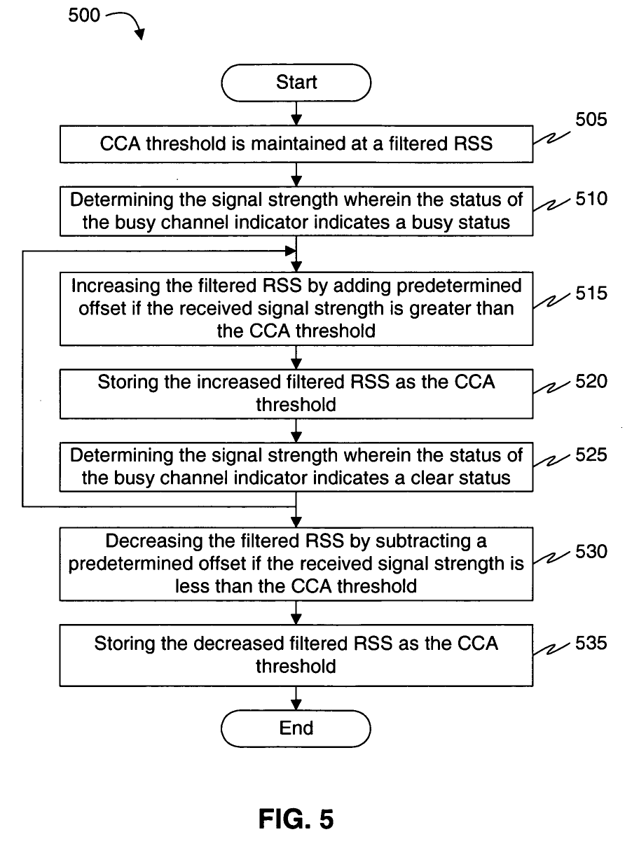

Turning now to FIG. 5, a flow diagram illustrating a method to adapt a CCA threshold in a wireless communication channel using received signal strength (RSS) as a parameter is shown and generally indicated at 500. In this embodiment the CCA threshold is adjusted directly from a RSS measurement. The CCA threshold, derived from the integration of the RSS, is maintained at a value based on the RSS. Accordingly, when the status of a busy channel indicator indicates a busy status, the CCA threshold may be increased at a predetermined rate, e.g., based on a first time constant of an RSS filter. Similarly, when the status of a busy channel indicator indicates a clear status, the CCA threshold may be decreased at a predetermined rate, e.g., based on a second time constant of the RSS filter.

In this embodiment, for instance, the CCA threshold is maintained at a positive predetermined offset from a low-pass filtered or “leaky-integrated” RSS, step 505. Summers may be used for performing integration of the RSS signal. A time constant for the RSS filter may be determined by the state of the CCA, for example, channel busy or channel clear. For instance, when the CCA indicates channel busy (e.g., as determined at step 510), the time constant may be slow so as to allow for the channel to be occupied by a non-malicious user for a nominal period of time. If, however, the CCA state indicates the channel busy for too long of a time interval, the filtered RSS output value may be increased to a value that, when added to the predetermined offset, will result in a threshold that causes the CCA status to toggle to the channel clear state, step 515. This increased filtered RSS output may be stored as the new CCA threshold, step 520.

The time interval for which the channel is allowed to be considered busy is determined by the RSS filter's “slow” time constant. When the CCA indicates channel clear (e.g., as determined at step 525), the RSS filter time constant may be increased to allow for a fast discharge of the RSS filter's output which may be decreased by subtracting a predetermined offset if the RSS is less than the CCA threshold, step 530. This provides a quick recovery from the channel busy to the channel clear operation, so that the CCA will properly indicate channel busy when the channel becomes busy, with a lower RSS than say a previous user, after a short channel clear period. The decreased filtered RSS output may be stored as the new CCA threshold, step 535.

In one embodiment, a slow increase in the CCA threshold is desired when there is an increase in the RSS. Raising the CCA threshold slowly during the time during which CCA indicates “busy” ensures that there would be no sudden cancellation of the “busy” status in the case of a legitimate packet step 515. The CCA threshold however, tracks the RSS more quickly in the time interval during which the CCA indicates a “clear” status step 530. Using a faster filter time constant causes the system to discharge the accumulated RSS energy within a very short time. This allows for asymmetric RSS duty cycles. As a result, the operating point of the CCA determination is modulated according to the background channel energy.

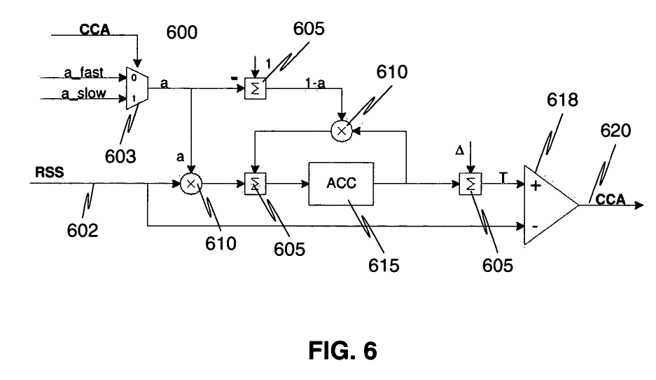

FIG. 6 shows a circuit diagram 600 of a system that may be used to implement the method described above by reference to FIG. 5. A CCA threshold (e.g., T), derived from a filtered RSS (602) is maintained at a positive predetermined offset from a low-pass filtered or “leaky-integrated” RSS by adding a positive predetermined value (e.g., Δ) to the leaky-integrator output. The summers 605, multipliers 610 and accumulator register 615 comprise the “leaky-integrator”. A time constant or response time of the leaky-integrator is determined by weights applied to the incoming RSS and feedback from the accumulator 615 output, where a weight value or factor is selected between two predetermined values (e.g., a_fast and a_slow) using a multiplexer, 603, according to the CCA signal (e.g., 620) also input into the multiplexer, 603. The CCA signal in this embodiment is binary valued (e.g., represented by a one (1) or a zero (0)).

When the busy channel indicator, CCA 620, indicates busy (e.g., a one), weighting factor a_slow may be used, resulting in a slow filter response to changes in the RSS input. Similarly, when the busy channel indicator, CCA 620, indicates a clear channel (e.g., a zero), weighting factor a_fast may be used, resulting in a fast filter response to changes in the RSS input. Upon comparing the RSS to the CCA threshold T using a suitable comparator 618, the busy channel indicator 620 (output from comparator 618) indicates a busy channel state when the RSS is greater than the CCA threshold and a clear channel state when the RSS is less than the CCA threshold. The filtered RSS, and hence the CCA threshold, tracks the RSS input at a rate determined by the weighting factors, a_slow and a_fast. Those of ordinary skill in the art will realize that apparatus 600 is merely exemplary apparatus for implementing the methods described herein and that different apparatus for enabling such implementation is well within the scope of the various embodiments described herein

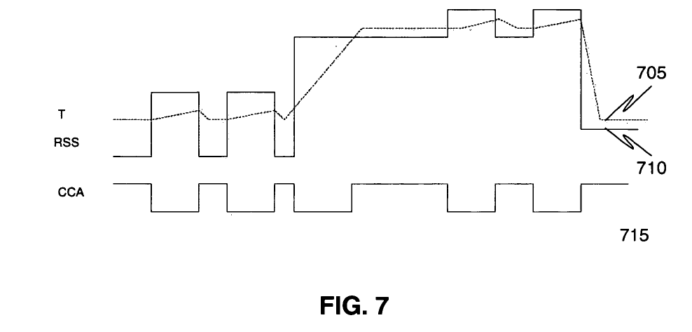

Turning now to FIG. 7, a signal diagram depicting the signals generated in the apparatus described above by reference to FIG. 6 is shown and indicated generally. The first signal 705 represents the CCA threshold, T, and the second signal 710 represents the RSS 602. The output of the busy channel indicator 620 is shown as signal 715. The busy channel indicator indicates the busy signal (e.g., one) when the RSS is greater than the CCA threshold. Due to the adaptive characteristic of the CCA threshold the status of the busy channel indicator shows a busy status for comparatively less time interval than the status of the busy channel indicator in prior art. Slowly increasing the CCA threshold limits the time allowed for the CCA to indicate the channel busy status, as the RSS has to be greater than the CCA threshold in order for the CCA to indicate the channel busy status.

Based on the status of the CCA, one of the two factors (a_fast and a_slow) is switched to the integrator. When the CCA indicates busy, a first factor a_slow is used to raise the CCA threshold, which is generally selected to yield a slow RSS filter time constant. A slow increase in the CCA threshold is desired to avoid a sudden increase in the CCA threshold due to a sudden burst of RSS. A significant increase in the CCA threshold for a period of time determined by the first factor, cancels the busy status of the CCA where the signal may be the due to a malicious intruder. If the RSS remains at an elevated level for an excessively long period of time, the CCA threshold settles to a higher value. A second factor a_fast, resulting in a faster RSS filter time constant, is employed when the CCA indicates a channel clear status. In one embodiment of the present invention the faster time constant causes the CCA threshold to track the RSS value more quickly.

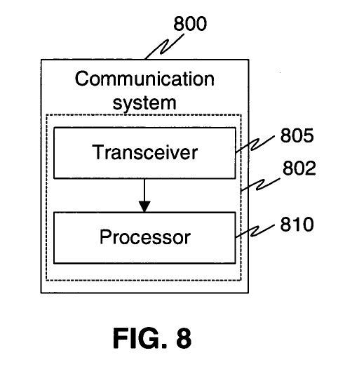

FIG. 8 shows the block diagram of a communication system 800 that may be used to implement the various embodiments of the present invention. System 800 may comprise one or more devices 802 (one shown for clarity) that may be access points and/or stations. An access point is defined as a hardware device or a computer's software that acts as a communication hub for users of a wireless device to connect to a Local Area Network (LAN). A station is defined as a wireless device, having no wired access to a LAN, which accesses the wireless network via an access point. A station may perform a subset of access point functions, but in general does not control access to the network. Each device 802 may comprise a conventional transceiver 805 as is well known in the art, a busy channel indicator (not shown) coupled to the transceiver 805 and a processor 810 coupled to the transceiver and the busy channel indicator. Skilled artisans will realize that various other elements, such as memory, the may be included in a commercial embodiment of system 800 is not shown for the purposes of simplicity and clarity. The busy channel indicator may be implemented in one embodiment in accordance with a CCA mechanism described in the 802.11 standards and in accordance with embodiments described herein. The processor may be configured either in hardware or software to perform the steps of the various methods embodied by the teachings herein.

As mentioned above, device 802 can be an access point or a station. Device 802 may also be a separate server, where the CCA threshold values can be determined based on the parameters disclosed above. Where the CCA threshold is determined on the separate server, the calculated increase or decrease in threshold can be communicated to the access point. According to one embodiment, the CCA threshold is calculated at the access point, the processor 810 and memory of the access point can work in conjunction to determine the status of a busy channel indicator for a predetermined parameter and correspondingly change the CCA threshold based on the status of the busy channel indicator. Those skilled in the art will appreciate that software and other components present on the communication system 800 can be configured to perform the tasks disclosed above and such software and components are within the scope of the present invention. The processor 810 can be configured to handle the overall functioning of a comparator and integrator and determining the status of the busy channel indicator. The processor 810 generally performs the operations at a physical layer level. The transceiver 805 may be a combined transmitter and receiver configured to handle the transmission and reception of communication signals.

In this disclosure various embodiments are provided that are complementary, and can be used for different types of jamming. For instance, the method to adapt the CCA threshold based on time interval can be used for intermittent preamble jamming. The method for adapting the CCA threshold based on RSS values and comparing the RSS value to the CCA threshold can be executed for continuous noise jamming. Keeping the CCA threshold constant can cause prolonged disruption of service due to the presence of intruders or noise or transmission of data that is not legitimate. Adapting the CCA threshold dynamically enables efficient and uninterrupted transmission of data on the transmission channel.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

What is claimed is:

1. A method for dynamically adapting a clear channel assessment threshold of a wireless communications channel, the method comprising the steps of:
determining a status of a busy channel indicator for at least one parameter; and
dynamically changing the clear channel assessment threshold based on the status of the busy channel indicator.

2. The method of claim 1, wherein determining the status of the busy channel indicator comprises the steps of:
comparing the clear channel assessment threshold to a received signal strength (RSS); and
indicating a busy status if the RSS is greater than the clear channel assessment threshold.

3. The method of claim 1, wherein the at least one parameter comprises a time interval.

4. The method of claim 3 further comprising the steps of:
determining a first time interval wherein the status of the busy channel indicator indicates a busy status; and
increasing the clear channel assessment threshold by a first predetermined value if the first time interval is greater than a first predetermined time value.

5. The method of claim 3 further comprising the steps of:
determining a second time interval wherein the status of the busy channel indicator indicates a busy status; and
decreasing the clear channel assessment threshold by a second predetermined value if the second time interval is less than a second predetermined time value.

6. The method of claim 1, wherein the at least one parameter comprises a received signal strength (RSS).

7. The method of claim 6, wherein the clear channel assessment threshold is maintained at a value based on the RSS.

8. The method of claim 7 further comprising the steps of:
determining that the status of the busy channel indicator for the RSS indicates a busy status; and
increasing the clear channel assessment threshold at a predetermined rate.

9. The method of claim 7 further comprising the steps of:
determining that the status of the busy channel indicator for the RSS indicates a clear status; and
decreasing the clear channel assessment threshold at a predetermined rate.

10. The method of claim 1, wherein the busy channel indicator is a Clear Channel Assessment indicator.

11. The method of claim 1, wherein the status of the busy channel indicator is determined in an access point.

12. The method of claim 1, wherein the status of the busy channel indicator is determined in a station.

13. A communication device comprising:
a transceiver;
a busy channel indicator coupled to the transceiver; and
a processor coupled to the transceiver and to the busy channel indicator and configured for performing the steps of:
determining a status of a busy channel indicator for at least one parameter; and
dynamically changing the clear channel assessment threshold based on the status of the busy channel indicator.

14. The device of claim 13, wherein the device is one of an access point and a station.

15. The device of claim 13, wherein the busy channel indicator is a Clear Channel Assessment indicator.

16. The device of claim 13, wherein the communication device is included in a system that is operated in accordance with a carrier sense multiple access/collision avoidance protocol.

17. A system that includes a device, the device comprising:
a transceiver;
a busy channel indicator coupled to the transceiver; and
a processor coupled to the transceiver and to the busy channel indicator and configured for performing the steps of:
determining a status of a busy channel indicator for a predetermined parameter; and
dynamically changing the clear channel assessment threshold based on the status of the busy channel indicator.

18. The system of claim 17, wherein the system is operated in accordance with a carrier sense multiple access/collision avoidance protocol.

19. The system of claim 17, wherein the device is one of an access point and a station.

20. The system of claim 17, wherein the busy channel indicator is a Clear Channel Assessment indicator.
